(19) United States
(12) Patent Application Publication
(10) Pub. No.: US 2014/0100929 A1
(43) Pub. Date: Apr. 10, 2014

(54) CONSUMER OFFER REDEMPTION METHODS AND SYSTEMS

(71) Applicant: Linkable Networks, Inc., Boston, MA (US)

(72) Inventors: Thomas Burgess, Portsmouth, RI (US); Francis Correra, Andover, MA (US); Douglas M. Spear, JR., Newport, RI (US)

(21) Appl. No.: 14/028,535

(22) Filed: Sep. 16, 2013

Related U.S. Application Data
(63) Continuation-in-part of application No. 13/197,279, filed on Aug. 3, 2011, now Pat. No. 8,560,389.
(60) Provisional application No. 61/370,559, filed on Aug. 4, 2010.

(51) Int. Cl. G06Q 30/02

(52) U.S. Cl. CPC G06Q 30/0215
USPC 705/14.17

(57) ABSTRACT

A computer-implemented offer redemption method and system for presenting offers to consumers and processing offer redemptions links offers from businesses directly to a payment account of a consumers, thereby eliminating the need for mail-in rebates or point-of-sale integration, and allows for the sharing of consumer information between different card link offer providers to facilitate the linking of rewards and registration of users. The computer-implemented offer redemption method includes the steps of: (a) presenting an offer to a consumer from an offering business, the offer covering a product or service or a purchase from a third-party; (b) receiving activation of the offer from the consumer prior to the consumer purchasing the product or service and storing it in the computer storage system; (c) determining whether the consumer is a registered user by searching a database of the offering business; (d) if the consumer is not registered with the offering business, asking the user for a unique identifier; and (e) searching a cooperative computer card link offer (“CLO”) network including multiple card link offer businesses for consumer data that match the unique identifier to determine if the consumer has previously registered with any other card link offer business.

### CROSS-REFERENCE TO RELATED APPLICATIONS

This application is a continuation-in-part of U.S. patent application Ser. No. 13/197,279, filed Aug. 3, 2011 and entitled “Consumer Offer Redemption Methods and Systems”, which claims priority to U.S. Provisional Application No. 61/370,559 filed on Aug. 4, 2010 and entitled “CONSUMER OFFER REDEMPTION SYSTEM” the entire contents of the above-identified applications being incorporated herein by reference in their entireties.

### BACKGROUND

The present application is generally directed to a method and system for presenting offers to consumers and processing offer redemptions. The system links offers from businesses directly to existing payment accounts of consumers, thereby eliminating the need for mail-in rebates or point-of-sale integration, and allows for the sharing of consumer information between different card link offer providers to facilitate the linking of rewards and registration of users.

### SUMMARY

A computer-implemented offer redemption method in accordance with one or more embodiments includes the steps of: (a) presenting an offer to a consumer from an offering business, the offer covering a product or service or a purchase from a third-party; (b) receiving activation of the offer from the consumer prior to the consumer purchasing the product or service and storing it in the computer storage system; (c) determining whether the consumer is a registered user by searching a database of the offering business; (d) if the consumer is not registered with the offering business, asking the user for a unique identifier; and (e) searching a cooperative computer card link offer (“CLO”) network including multiple card link offer businesses for consumer data that match the unique identifier to determine if the consumer has previously registered with any other card link offer business.

In one embodiment, the step of searching a cooperative CLO business network for the consumer includes the steps of: (f) sending a consumer's unique identifier, for example the consumer's email or other consumer identifier to each member of the CLO business network (i.e. peers); (g) requesting that each member of the CLO business network search their local database for consumer data that includes a match to the consumer's unique identifier; (h) receiving a reply from the members of the CLO business network as to whether a match to the consumer's unique identifier was found; and (i) recording the consumer data with the offering business if a match is found. Additionally, the requestor, upon receiving consumer data from at least one member of the cooperative CLO business network, can then notify the other peers that the consumer has been found.

Once the registered consumer is found, the computer-implemented offer redemption method may proceed with the steps of: (j) linking the activated offer to the consumer's payment instrument after receiving activation of the offer from the consumer; (k) monitoring transactions made over a period of time in the consumer's payment account using the computer storage system to determine when the consumer has purchased the product or service or made a purchase from the retailer covered by the linked offer using the consumer's payment account; and (l) making payment for offer settlement to a payment processor managing the consumer's payment account to be credited to the consumer automatically, without further action required by the consumer.

In an alternate embodiment, once the registered consumer is found, the computer-implemented offer redemption method may proceed with the steps of: (j) linking the activated offer to the consumer's payment instrument after receiving activation of the offer from the consumer; (k) monitoring transactions made over a period of time in the consumer's payment account using the computer storage system; (l) using the computer storage system to filter out ineligible transactions in the consumer's payment account that do not meet offer criteria; (m) transmitting a verification request to an offer issuer or third party data provider using the computer storage system for any transactions that remain in the consumer's payment account after filtering out ineligible transactions to verify that the transaction is covered by the offer by matching a unique identifier of a product or service purchased in the transaction with a unique identifier specified in the offer; and (n) when the transaction is verified by the offer issuer to be covered by the offer, making payment for offer settlement to a payment processor managing the consumer's payment account to be credited to the consumer automatically, without further action required by the consumer.

A computerized offer redemption system in accordance with one or more embodiments comprises at least one processor, memory associated with the at least one processor, and a program supported in the memory for processing offers provided to consumers. The program includes a plurality of instructions stored therein which, when executed by the at least one processor, cause the at least one processor to: (a) receive activation of an offer from the consumer covering a product or service or a purchase from a retailer prior to the consumer purchasing the product, service or purchase; (b) determine whether the consumer is a registered user by searching the local database of the card link offer business sponsoring the offer; (c) request a unique identifier from the consumer if the consumer is not a registered user of the sponsoring CLO business; (d) send a consumer's unique identifier to each member of a CLO business network; (e) request that each member of the CLO business network search their local database for consumer data including a match to the consumer's unique identifier; (f) receive a reply from each member of the CLO business network; (g) record the consumer data if a consumer is found in one of the local CLO databases; (h) store the consumer data including the consumer's payment account associated with the consumer in a memory; (i) link the activated offer to the consumer's payment account after receiving activation of the offer from the consumer; (j) monitor transactions made over a period of time in the consumer's payment account; and (k) when the consumer has purchased the product or service or made a purchase from the retailer covered by the linked offer using the consumer's payment account, make payment for offer settlement to a payment processor managing the consumer's payment account to be credited to the consumer automatically, without further action required by the consumer.

A computerized offer redemption system in accordance with one or more further embodiments comprises at least one processor, memory associated with the at least one processor, and a program supported in the memory for processing offers provided to consumers. The program includes a plurality of instructions stored therein which, when executed by the at least one processor, cause the at least one processor to: (a) receive activation of an offer from the consumer covering a product or service or a purchase from a retailer prior to the consumer purchasing the product, service or purchase; (b) determine whether the consumer is a registered user by searching the local database of the card link offer business sponsoring the offer; (c) request a unique identifier from the consumer if the consumer is not a registered user of the sponsoring CLO business; (d) send a consumer's unique identifier to each member of a CLO business network; (e) request that each member of the CLO business network search their local database for consumer data including a match to the consumer's unique identifier; (f) receive a reply from each member of the CLO business network; (g) record the consumer data if a consumer is found in one of the local CLO databases; (h) store the consumer data including the consumer's payment account associated with the consumer in a memory; (i) link the activated offer to the consumer's payment account after receiving activation of the offer from the consumer; (j) monitor transactions made over a period of time in the consumer's payment account; (k) determine whether a transaction in the consumer's payment account is potentially covered by the linked offer by filtering out ineligible transactions in the consumer's payment account that do not meet offer criteria; and (l) when the transaction is determined to be potentially covered by the linked offer, transmit a verification request to an offer issuer or third party data provider to verify that the transaction is covered by the offer by matching a unique identifier of a product or service purchased in the transaction with a unique identifier specified in the offer; (m) when the transaction is verified by the offer issuer to be covered by the offer, automatically making a payment for offer settlement to a payment processor to be credited to the consumer automatically, without further action required by the consumer.

### BRIEF DESCRIPTION OF THE DRAWINGS

The foregoing and other objects, features and advantages will be apparent from the following description of at least one exemplary embodiment, as illustrated in the accompanying drawings in which like reference characters refer to the same or similar components throughout the different views. For purposes of clarity, not every component may be labeled in every figure. The figures are included to provide an illustration and a further understanding of the various aspects and embodiments, and are incorporated in and constitute part of the specification, but are not intended as a definition of the limits of any particular embodiment. The drawings are not necessarily to scale, emphasis instead being placed upon illustrating the principles disclosed herein.

FIG. 1 illustrates an exemplary consumer offer redemption process in accordance with one or more embodiments;

FIG. 2 illustrates an exemplary offer redemption process flow in accordance with one or more embodiments; and

FIG. 3 illustrates an exemplary offer redemption process including a cooperative business network for sharing consumer information between rewards providers.

### DETAILED DESCRIPTION OF THE ILLUSTRATIVE EMBODIMENTS

The embodiments disclosed herein provide an offer redemption system and method for processing, storing, tracking, recording and redeeming offers that are made available to consumers. The offers are linked by the offer processing system to a consumer payment account that is registered with the offer processing system in order to link and redeem the offer. Upon redemption of the offer by the consumer using the registered consumer payment account, the offer processing system process the transaction and initiates an offer settlement to the consumer automatically, without further action required by the consumer, as described in greater detail herein below.

The methods and systems disclosed herein are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples or embodiments are not intended to be excluded from a similar role in any other examples or embodiments.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Additionally, a variety of different types of consumer payment accounts or methods can be used in connection with the methods and systems described herein. In various examples described herein, the payment accounts of the consumers are described as being credit/debit accounts. This is by way of example only, and it should be understood that a variety of other types of consumer payment accounts and/or payment methods can be utilized including, but not limited to, gift cards, prepaid cards, online money transfer accounts such as PayPal and eWise accounts, mobile payment accounts, virtual money accounts, and rewards or points accounts. If a credit and/or debit card is utilized it can be either an open loop or closed loop card. In addition, instead of using a credit/debit card having account information presented in a magnetic stripe on the back of the card, payment and account details can be presented to merchants through a variety of other media, methods, and devices including, but not limited to, smart phones, retinal/finger scans, RFID tags, and any other technology implemented to process payments. Therefore, as used herein, the term “credit/debit card” is not intended to be limiting and includes any payment card, method, device, account or technology which processes payments and the form of payment method or account.

Also, although the examples described herein refer to banks as the entities managing consumer payment accounts, it should be understood that a variety of other types of payment processing entities and financial institutions can be used including, e.g., a credit or debit card issuer, payment networks (for example MasterCard, Visa, AMEX, Discover, etc.), an online money transfer service, a mobile payment service, an alternative currency issuer, a points or rewards processing system, or a third-party settlement provider.

As also used herein, the term “offer” refers to an incentive presented to a consumer. Such incentives may include, but are not limited to, rebates for purchasing a particular product or service (or a collection of products or services) or for making a purchase from a particular retailer (or group of retailers), or other inducements that encourage the consumer to purchase a product, service, membership, or the like. Offers can include restrictions such as, e.g., retailer constraints, product or SKU-level constraints, date constraints, and purchase amount constraints.

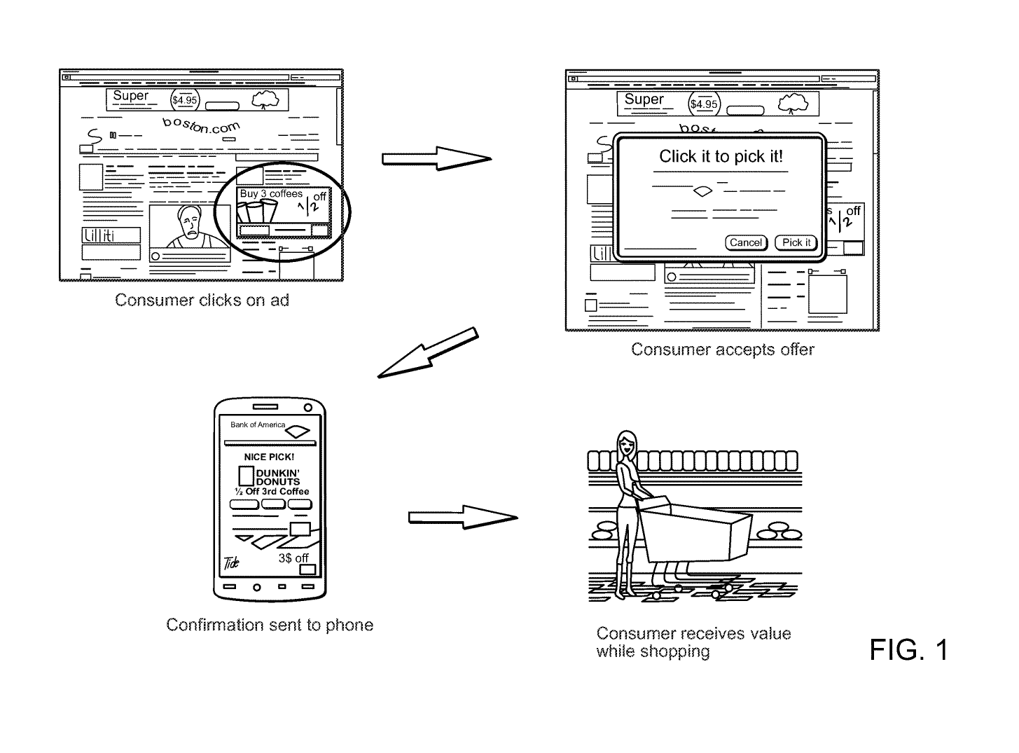

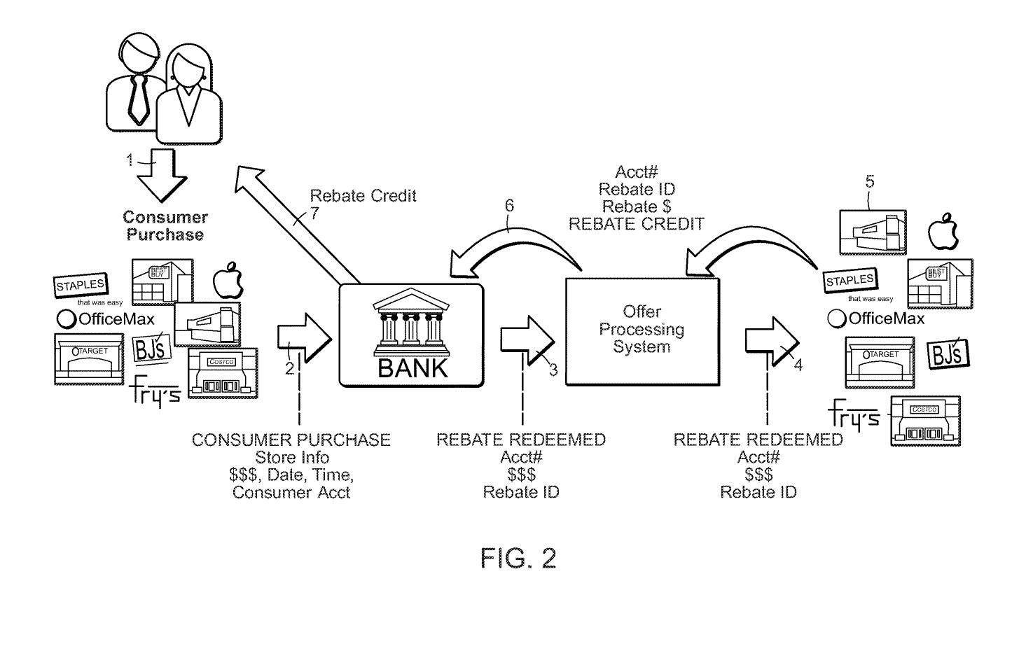

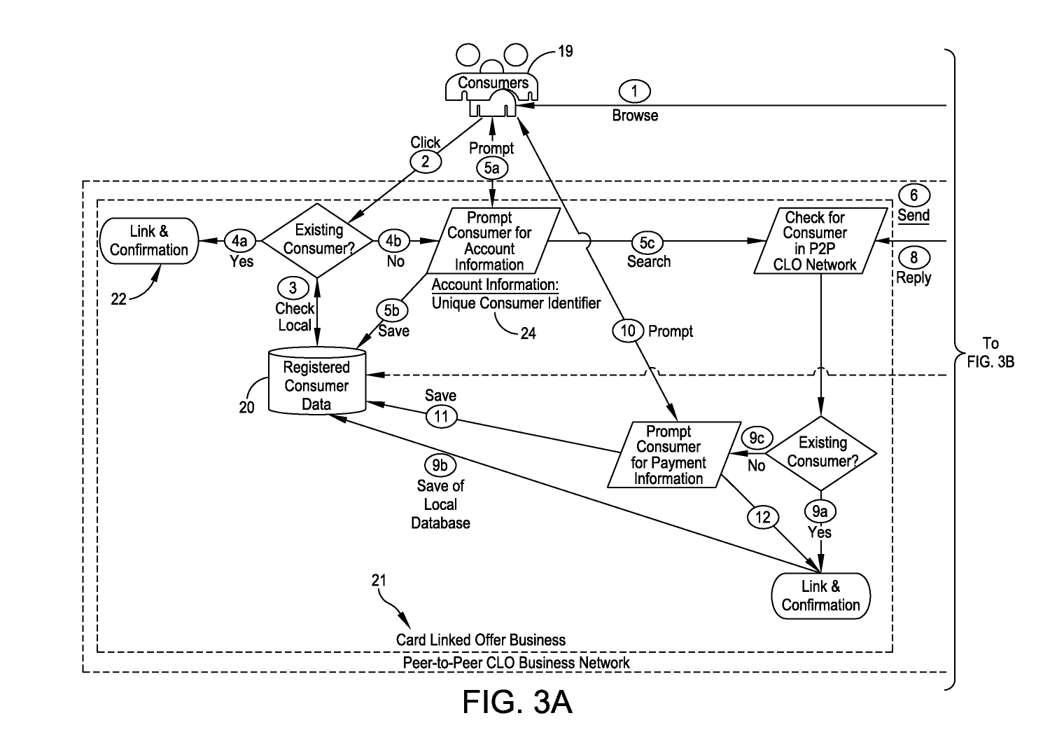

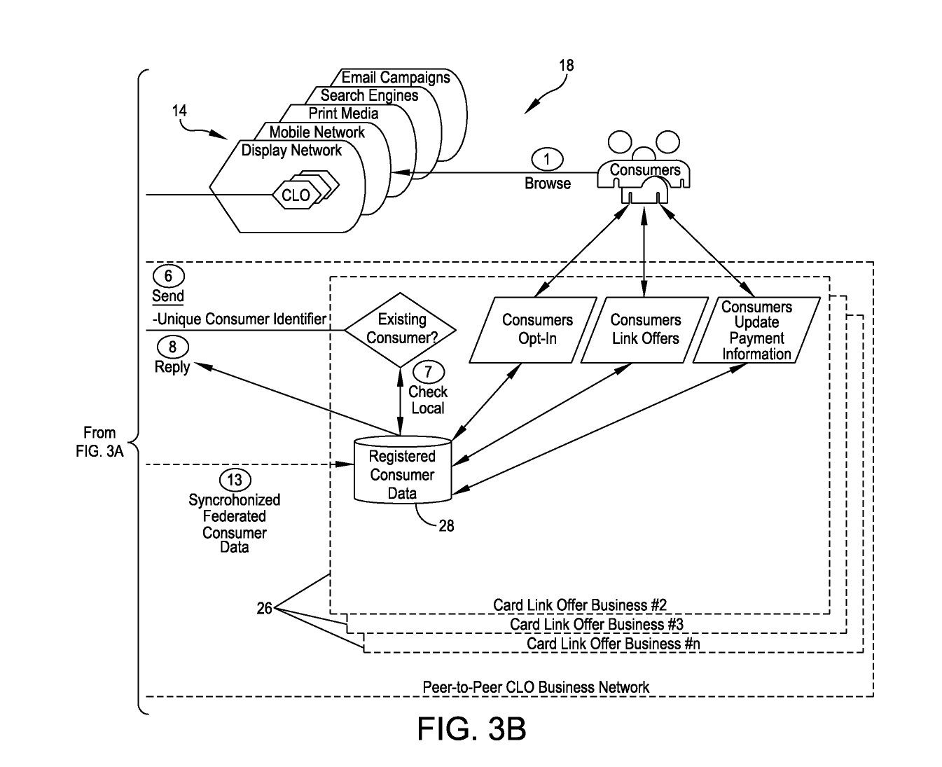

Referring to FIG. 1, there is illustrated one example of how a consumer can use an advertised offer to obtain an incentive, for example a rebate, for purchasing a product or service. Consumers initially register one or more credit or debit cards (or other payment methods) with a card linked offer (“CLO”) business or provider (FIG. 2), for example by registering with the CLO provider's offer processing system. Once a card is registered, a consumer can easily link offers to their card by, for example by clicking on an offer, scanning an offer, or texting a response to an offer. The offer processing system can enable virtually any type of advertising media for presenting offers including, but not limited to, mobile, online, and off-line advertising. In the exemplary embodiment of FIG. 1, the consumer is presented with an offer in the form of an advertisement 10 displayed on a webpage 12. The consumer clicks on the advertisement in order to link (i.e., accept and activate) the offer 14. The CLO provider's offer processing system receives the consumer's acceptance of the offer 14 and identifies the consumer (from prior consumer registration) as described in greater detail below with respect to FIG. 3. The offer processing system then associates the offer to the consumer's registered credit/debit card, and sends a notification 16 (e.g., an email or text message) to the consumer confirming the linked offer and optionally providing any terms and conditions of the offer. Following a qualified purchase by the consumer (i.e., use of the linked card to make a purchase in accordance with the offer terms and conditions), the rebate or savings offered are automatically settled back to the consumer's payment account or to another account of the consumer's choosing (for example gift cards, points in a reward program, payment to a third-party, etc.), as will be described in further detail below in connection with FIG. 2.

In one or more embodiments, the offer processing system can be used to create campaigns for offering consumer rebates and/or rewards across display and mobile advertising networks. Consumers can accept offers by clicking on display or mobile network advertised rebate offers. Campaigns offering consumer rebates can also be created across radio, television, print, and digital out of the home networks (DOOH). Consumers can link these offers to their payment accounts in various ways including, e.g., by using a cell phone to text a response to the offers. Consumers can also use a Smartphone application to bar code scan, quick response (QR) code scan, tag code scan, or **code a mobile response to display, mobile, print, or DOOH advertised offers and link such offers to their credit/debit cards. After a consumer accepts an offer, the offer processing system links the offer to the consumer's credit/debit card, as described herein below.

If the consumer attempts to accept an offer and they are not registered with the offering business, i.e. the CLO provider that is running the offer, the offer processing system can initiate a search of other CLO providers through a CLO network 18 as illustrated in FIG. 3. By utilizing a peer-to-peer network of CLO business providers, if the consumer is registered with another CLO provider, the consumer's information can be shared between CLO providers so that the consumer does not have to register again with the offering business. In this manner, consumers will be saved the time and effort of registering with each individual CLO business, providing the same information and requiring the consumer to “opt-in” to each CLO program. Through the CLO network 18, participating CLO businesses can exchange information using a peer-to-peer architecture, allowing the participating CLO business to a) share consumer registration data; b) prevent fraud; c) manage offer “stacking”; and d) share revenue across the CLO businesses, as well as other advantages.

In order to determine if the consumer is registered with the offering business or any of the other CLO businesses, the following steps as illustrated in FIG. 3 may be utilized in the present exemplary embodiment:

1. The consumer 19 browses one of the advertising channels and is presented with an offer 14 from the offering business 21 who is a member of the cooperative CLO business network.

2. The consumer accepts the offer 14, for example by clicking on the offer, or in any other manner as described herein.

3. Upon receiving the consumer's acceptance, the offering business 21 checks their local database 20 of registered consumers for the existence of the consumer 19 in order to link the offer 14 to the consumer's registered payment method.

4a. If data matching the consumer 19 is found in the local database 20 of the offering business 21, the offer is linked to the consumer's registered payment account and confirmation of the link is sent to the consumer;

4b. If data matching the consumer is not found in the local database 20 of the offering business 21, the CLO network 18 can be used by the offering business 21 inputting the consumer into a new account workflow;

5a. The offering business 21 prompts the consumer 19 to supply a unique identifier 24, for example an email address or other consumer identifying information such as social network (Facebook, Google or Twitter) credentials, phone number, etc.

5b. The unique identifier 24 associated with the consumer is saved in the local database 20 of the offering business 21.

5c. The other members 26 of the CLO business network 18 are then requested to search for a consumer having data that matches the unique identifier 24.

6. A request to find the consumer matching the unique identifier 24 can be sent to the other members 26 of the cooperative CLO network 18 (Business #2 through Business #n) by the offering business 21 (who is also a member business of the CLO network 18) in order to search for already collected consumer data which includes the unique identifier 24.

7. Upon receiving a request for consumer data, members 26 of the cooperative CLO network 18 search their local databases 28 of registered consumers for consumer data matching the unique identifier 24 provided by the offering business 21.

8. Each member 26 of the cooperative CLO network 18 replies back to the offering business 21 with the results of their search. For example, a “consumer not found” message, or a message containing the collection of consumer data, if matching consumer data is found in their local database.

9a. The offering business 21, upon receiving the consumer data from at least one member 26 of the cooperative CLO network 18, records the consumer data (9b), links the offer 14 to the payment account of the consumer 19 and notifies the consumer that they've successfully linked the offer 14. The offering business 21 (or requestor) may also record the details of which peer CLO business shared the consumer data in order to stay in synch with this peer.

9b. The consumer's information is recorded in the local database 20 of the offering business 21 in order to register the consumer.

9c. Alternately, if the consumer's data is not found after searching the local databases 28 of registered users, the offering business 21 prompts the consumer 19 to enter their information, including payment instrument into a new account, for example as described in greater detail below with reference to FIGS. 1&2.

10. The consumer 19 enters the requested information, including their payment information to the offering business 21.

11. The offering business 21 records the consumer's information in their local database 20.

12. The offering business 21 links the offer 14 to the consumer's payment account and notifies the consumer that they've successfully linked the offer 14.

13. Consumer data may be synched between businesses in the cooperative CLO network 18 in order to keep the local databases of the CLO business network up-to-date.

Each member business may periodically synchronize consumer data with peer members of the CLO business network 18. The synching of consumer data may be done asynchronously to consumer interaction with any of the members of the cooperative CLO business network 18. Data synchronization may take place between businesses that have exchanged data based on a consumer action and the synchronization may exchange data that has changed since the last synchronization event.

Some events that may trigger cooperative synchronization 13 include, but are not limited to, consumer opt-out, lost/stolen payment methods, expired payment methods, change of payment address information or changes to any other consumer information.

Referring now to FIG. 2, there is illustrated an exemplary cardholder retention pathway in accordance with one or more embodiments as follows:

Step 1: The consumer purchases a particular product or service associated with a previously linked rebate offer at a retail store (or makes a purchase at a particular retail store associated with a linked rebate offer) using a registered credit/debit card.

Step 2: The retailer transmits debit details relating to the purchase to the credit/debit card issuing institution or bank for transaction clearing purposes. The debit details can include the retail store information, the amount of the purchase, the date and time of the transaction, and the consumer account number, among other data.

Step 3: The offer processing system (labeled in FIG. 2 as “Offer Processing System”) monitors active consumer payment transactions via direct access to the bank (or other payment vehicle source, e.g., mobile wallet) or through a third party data provider to match consumer purchase data (from the debit details) to linked offers.

Step 4: The offer processing system communicates matched rebate/purchase details to the offer issuing entity, which can be, e.g., the retail store, product manufacturer, or distributor.

Step 5: The offer issuing entity verifies that the purchase qualifies for the offer. In particular, the offer issuing entity verifies that particular products or services covered by the offer were purchased by the customer in the customer transaction, for example, by matching specific transaction data, such as whether the product or service was purchased on a certain date or range of dates, from a specified retailer, at or above a specified price, or in combination with other products.

Step 6: Upon validation of the purchase as a qualified purchase, the offer processing system issues settlement instructions to the card issuing institution or bank. In one or more embodiments, the settlement instructions include an authorization for the bank to withdraw funds from a given account for rebate settlement.

Step 7: The cardholder's issuing bank associates the settlement instructions with the customer's credit/debit card information and makes payment to the customer's credit/debit card.

In the exemplary process described above, Steps 4-5 apply particularly to offers covering the purchase of a particular product or service. For offers relating to purchases from a particular retailer, no offer validation by the offer issuing entity is required since the offer processing system will know from Step 3 whether the requirements of the offer have been met. For example, the offer processing system will know whether the consumer has purchased a minimum qualifying amount at a particular retailer or group of retailers specified in the offer.

In this way, consumers can accept offers, make purchases of products or services, and automatically receive rebates or other incentives without the inconvenience of using coupons or a mail-in rebate.

After the consumer has accepted the offer and the offer is linked to the consumer's payment method, a confirmation of the linked offer may optionally be sent to the consumer, for example, by mobile or other electronic, telecommunication, or computing device through methods such as email, text or through the consumer's registered account. The offer remains linked to the payment method until redeemed by the consumer or removed by the consumer. To redeem the offer, the consumer simply satisfies the conditions of the offer as described above, and makes payment by the linked consumer payment account.

Because the offer is linked to the consumer's payment account, the offer can be redeemed either on-line or at a physical location. The consumer may redeem the offer by making a purchase, for example, at an offline, brick and mortar store and paying for the purchase using the registered payment account. Once the consumer redeems the offer and makes payment using the linked consumer payment account, the consumer's purchase transaction data travels along the financial lines to the card-issuing bank or other payment issuer, (which has been authorized by the consumer during the initial payment registration process), typically on a daily basis.

Alternately, the computer storage system may be used to filter out ineligible transactions in the consumer's payment account that do not meet the offer criteria and may thereafter transmit a verification request to an offer issuer or third party data provider using the computer storage system for any transactions remaining in the consumer's payment account. Thereafter, verification of any remaining offer may be accomplished as described above.

In one exemplary embodiment, a unique identifier of a product or service purchased may be matched to a unique identifier specified in the offer to verify that the transaction data meets the affiliate offer criteria by a computer storage system. For example, the unique identifier may include a stock-keeping unit (SKU) code or a radio-frequency identification (RFID) code, or other unique identifiers.

For SKU (Stock-Keeping Unit) tracking, the methods and systems utilize SKU level tracking. An exemplary SKU level tracking process is described below.

Step 1: A rebate offer campaign for a particular product is initiated, e.g., by an advertising agency, a brand, a retailer, or a manufacturer, as described herein above.

Step 2: As part of the campaign set-up, the following offer information (among other information) is loaded into the offer processing system and stored in a computer storage system:
Manufacturer Name (e.g., Panasonic™)
Retailer(s) Name (e.g., Best Buy™, Staples™)
UPC of advertised item (typically common to all retailers)
SKU of advertised item (typically specific to each retailer)
Price of advertised item

Step 3: The offer processing system retains this information in a campaign database for a SKU level refund from the manufacturer when a consumer completes purchase of a product identified by the SKU. This information can assist with attribution tracking

Step 4: The offer processing system distributes the campaign across the designated media to meet the targeting requirements of the advertiser.

Step 5: A consumer registered with the offer processing system links a SKU-level offer, e.g., by clicking on an enabled offer presented on a website or other media as described above. SKU-level offers are specific to individual products, e.g., 10% off a Panasonic™ 12.1 Megapixel Digital Camera (UPC xxx, retailer SKU xxx—by Jun. 15, 2012).

Step 6: The consumer makes a qualified purchase at a retailer. In this case that entails purchasing the specific product or making a purchase from a particular retailer identified in the offer and in accordance with any other offer terms and conditions.

Step 7: The retailer transmits debit details relating to the purchase to the credit/debit card issuing bank for transaction clearing purposes. The debit details can include the retail store information, the amount of the purchase, the date and time of the transaction, and the consumer account number, among other data. The information typically does not include SKU data.

Step 8: The offer processing system monitors active consumer payment transactions via direct access to the bank (or other payment vehicle source, e.g., mobile wallet) or through a third party data provider to match consumer purchase data (from the debit details) to a retailer or set of retailers designated in the campaign.

Step 9: When consumer transactions at a designated retailer are identified, the offer processing system performs a preliminary transaction-to-offer matching process to identify possible qualified transactions by eliminating transactions that do not meet the rebate criteria (e.g., the purchase amount is less than the SKU item price, a date constraint is not satisfied, or a retailer constraint is not satisfied).

Step 10: The offer processing system periodically provides a list of potentially qualifying transactions to the designated retailer(s) or third party SKU data provider, i.e. those transactions that have not been eliminated in Step 9, and requests that the retailer(s) or third party SKU data provider verify offer compliance. This request may be sent directly from the offer processing system to retailer or it may pass through a clearinghouse partner company or other third-party. For example, for any purchases that appear within the rebate criteria (e.g., a $299 purchase on May 31, 2010), a verification request is sent to the retailer (e.g., Best Buy). By way of example only, the verification request may contain the following information:
Verification request identifier (e.g., request for verification that user X purchased a Panasonic™ 12.1 Megapixel Digital Camera—Black)
Purchase transaction identifier (e.g., consumer credit card number, transaction number)
Transaction store identifier
Transaction date/time stamp
Transaction amount
List of eligible SKU numbers (1 . . . n)
List of eligible Manufacturer UPC numbers (1 . . . n)
Purchase authorization identifier

Step 11: The retailer (e.g., Best Buy) or third party SKU data provider determines whether the purchase meets the requirements of the offer. Specifically, the retailer(s) or third party SKU data provider uses the data provided by the offer processing system to search its transaction records for a unique transaction that best matches the transaction data provide by the system. When a match is made, the retailer(s) or third party SKU data provider reviews the basket or SKU data associated with the transaction to determine whether a qualified purchase has been made.

As part of the data review, the retailer(s) or third party SKU data provider may also elect to confirm that the transaction satisfies other offer conditions, including but not limited to whether (i) a retailer level offer has been applied to excluded items (e.g., a gift card or cash back on a debit card), (ii) the consumer has returned the goods for a credit as part of a future transaction, thus eliminating the qualifying sale, (iii) the consumer has impermissibly stacked offers (e.g., presented a paper coupon for a 10% discount and attached a card linked offer for another 10% rebate).

Step 12: The retailer (e.g., Best Buy) or third party SKU data provider sends the offer processing system the results of the verification request. By way of example, the results can include:
A verification request identifier matching the identifier used in the verification request.
Result status, which can, e.g., be SUCCESS, FAILURE-RETRY (request could not be processed, try again later) or FAILURE STOP (request could not be processed, do not retry) or TRANSACTION-MULTIPLE-MATCH (multiple transactions matched the verification request data).
SKU Details (one for each SKU in the list of SKU specified in the verification request), the details can include SKU number, verification status (which can be SKU-PRESENT or SKU-NOT-PRESENT), Return status (which can be SKU-RETURNED or SKU-NOT-RETURNED), and discount status (which can be DISCOUNT-APPLIED or DISCOUNT-NOT-APPLIED).

Step 13: If the results of the verification request indicate a rejection of the transaction, no rebate is applied to the consumer's credit/debit card. If the results indicate an approval of the transaction, a rebate is applied to the consumer's credit/debit card.

Step 14: An advertiser may access the offer processing system for campaign performance data periodically (e.g., once a day). Campaign data can include a record of approved rebates and an invoice for the amount. The offer processing system can also be set to alert the advertiser of performance thresholds to help manage success of campaigns. The offer processing system can also provide a record of rejected transactions.

The functions of the offer processing system and other processes described above may be implemented in software, hardware, firmware, or any combination thereof. The processes are preferably implemented in one or more computer programs executing on a programmable computer including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alteration, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the offer processing system may comprise one or more physical machines, or virtual machines running on one or more physical machines. In addition, the offer processing system may comprise a cluster of computers or numerous distributed computers that are connected by the Internet or another network.

Accordingly, the foregoing description and attached drawings are by way of example only, and are not intended to be limiting.

What is claimed is:

1. A computer-implemented offer redemption method in accordance with one or more embodiments includes the steps of:
presenting an offer to a consumer from an offering business, the offer covering a product or service or a purchase from a third-party;
receiving activation of the offer from the consumer prior to the consumer purchasing the product or service and storing it in the computer storage system;
determining whether the consumer is a registered user by searching a computer database of the offering business;
asking the user to input a unique identifier if the consumer is not registered with the offering business; and
searching a cooperative computer card link offer (“CLO”) business network including multiple card link offer businesses for consumer data to match the unique identifier to determine if the consumer has previously registered with any other card link offer business.

2. The method of claim 1, wherein the step of searching a cooperative CLO business network further includes the steps of:
sending a consumer's unique identifier to each member of the CLO business network;
requesting that each member of the CLO business network search their local database for consumer data that includes a match to the consumer's unique identifier;
receiving a reply from the members of the CLO business network as to whether a match to the consumer's unique identifier was found; and
recording the consumer data with the offering business if a match is found.

3. The method of claim 2, further comprising the step of synchronizing consumer data between each member of the CLO business networks' local databases.

4. The method of claim 1, further comprising the steps:
(i) linking the activated offer to the consumer's payment instrument after receiving activation of the offer from the consumer;
(j) monitoring transactions made over a period of time in the consumer's payment account using the computer storage system to determine when the consumer has purchased the product or service or made a purchase from the retailer covered by the linked offer using the consumer's payment account; and
(k) making payment for offer settlement to a payment processor managing the consumer's payment account to be credited to the consumer automatically, without further action required by the consumer.
